(19) United States
(12) Patent Application Publication
(10) Pub. No.: US 2012/0166263 A1
(43) Pub. Date: Jun. 28, 2012

(54) CUSTOMER INTRODUCTION SUPPORT SYSTEM

(76) Inventor: Ken Tsuboi, Tokyo (JP)

(21) Appl. No.: 13/322,661

(22) PCT Filed: May 24, 2010
(86) PCT No.: PCT/JP2010/058730

§ 371 Date: Mar. 7, 2012

(30) Foreign Application Priority Data
May 29, 2009 (JP) 2009-129983

(51) Int. Cl. G06Q 30/02

(52) U.S. Cl. 705/14.16

(57) ABSTRACT

This invention is to present a support system preferably utilized in sales promotions of items by introductions.

As shown in FIG. 1, an introducee information file, an item information file, and an introducer information file are memorized in a storage of a web server 1. An introducer can browse item information in the item information file at an introducer computer 51, and submit an introduction report therefrom to the web server 1 when an introduction has been made for an item. The submitted introduction report is recorded in a report information file, and forwarded to the introducee computer 52 in form of an E-mail by a forwarding program.

### TECHNICAL FIELD

This invention relates to a customer introduction support system utilized preferably in carrying out sale promotion by giving a reward to someone having introduced a customer.

### BACKGROUND ART

Personal connection is regarded as significant in Japanese society. Introduction by a person often becomes a major factor in selling goods or services (hereinafter referred as “item” as generic term). A person who bought an item often introduces it to another person. It is also popular in many cases that a person intending to order a contract job would order the job not to an unknown company but to another one having an introducer.

Considering these things, it is also popular to give incentives such as cashback points (i.e., discount in next purchases) and payments of commissions, to introducers of items.

### PRIOR TECHNICAL REFERENCES PATENT REFERENCES

Patent Reference 1: Japanese Publication No. 2005-004309 Gazette

### DISCLOSURE OF THE INVENTION

### Problem the Invention Will Solve

By the former method, that is, offering cash back points, however, much incentives are not given to introducers because there is no other merits than discounts in next purchases for the introducers. Although the latter method, that is, payments of introduction commissions, would be much incentives because introducers can expect cash incomes, a party asking an introduction (hereinafter referred as “introducee”) needs to make a contract beforehand with each introducer. This might be troublesome. Especially, if the commission price for introductions, the payment condition or any other thing is intended to be changed in the contracts, it would be much troublesome because each contract with each introducer needs to be updated respectively.

As another problem, a dispute might arise between an introducer and an introducee. A typical example is the case that no prescribed commission is paid even though an introduction has been done. This kind of dispute is solved through a litigation ultimately. However, it is much troublesome to carry out a lawsuit on every dispute. One of the factors making dispute solutions troublesome is that there is no third-party to intermediate between introducers and introducees. If a third party proves to some extent such a fact as execution of introduction, prevention of disputes would be possible.

This invention was done to solve the above described problems, and presents a support system preferably utilized in promoting sales of items by introductions. The system has the advantage of reducing labors at introducees and is useful in preventing disputes.

### Means For Solving the Problem

To solve the above described problems, the invention as claimed in the claim 1 is a support system comprising a server connected both to introducee computers handled by introducees wishing to be introduced to customers, and to introducer computers handled by introducers intending to introduce the introducees to customers; wherein
a storage of the server memorizes
   an introducee information file in which information about the introducees is recorded;
   an item information file in which information about items merchandised by the introducees is recorded,
   an introducer information file in which information about the introducers is recorded including information necessary in paying rewards,
   an item information input page file to make the introducee computers input and submit the item information,
   an introducer information input page file to make the introducer computers input and submit the introducer information
   an item information browse page file to browse the item information recorded in the item information file; and
   an report submission page file to make the introducer computers select items and submit to the server introduction reports that introductions have been done for the selected items;
on the server, are implemented
   an item information register program to record the item information in the item information file when the item information is submitted from one of the introducee computers on which the item information input page is displayed,
   an introducer information register program to record the introducer information in the introducer information file when the introducer information is submitted from one of the introducer computers on which the introducer information input page is displayed,
   an item information browse program to readout the item information from the item information file, transmit to one of the introducer computers the item information browse page file with the item information laid in, and make the item information browsed thereon, when an access has been made from the introducer computer,
   a report submission program to make the introduction reports submitted from the introducer computers to the server, and
   a forwarding program to forward each introduction report to each introducee computer when each introduction report is submitted from each introducer computer by the report submission program;
the item information includes the information about the rewards for introductions of items to third parties and conditions on payments of the rewards;
each introduction report includes item identifying information to identify each item for which each introduction has been done, introducee identifying information to identify each introducee for each item, introducer identifying information to identify each introducer for each introduction, and information about each third party introduced to;
the forwarding program is programmed so as to search the introducer information file according to the submitted introducer identifying information, and forward each introduction report with information on each introducer acquired from the introducer information file.

To solve the above described problem, the invention claimed in the claim 2 is a support system as claimed in the claim 1, wherein
E-mail addresses are included in the introducee information recorded in the introducee information file as attentions of the introduction reports, and
the forwarding program is programmed so as to acquire each E-mail address by searching the introducee information file according to the submitted each piece of the introducee identifying information.

To solve the above described problem, the invention claimed in the claim 3 is a support system as claimed in the claim 1 or 2, wherein
a report information file where each of the introduction reports is recorded in form of database is memorized in the storage of the server,
the report submission program is programmed so as to record additionally the introducer information in the report information file when each of the introduction reports is submitted.

To solve the above described problem, the invention claimed in the claim 4 is a support system as claimed in the claim 3, wherein
the storage of the server memorizes an introducee report-browse page file to enable the introducee computers to display contents of the report information file for browsing, and
on the server is implemented an introducee report-browse program, which is programmed so as to readout one or more introduction reports for one of the introducees from the report information file, and transmit the introduction report browse page file with the introduction reports laid in, when the introducee computer handled by the introducee has made an access.

To solve the above described problem, the invention claimed in the claim 5 is a support system as claimed in the claim 4, wherein
the introducee report-browse page file displays a settlement inputbox for each of the one or more introduction reports,
a settlement register program is implemented on the server,
the settlement register program is to be executed when settlement is input in one or more settlement inputboxes in the introducee report-browse page file after the introducer report-browse file with the one or more introduction report laid in is transmitted to the introducee computer and displayed thereon, and is to record and register the settlement for the introduction reports for which the input has been done, in the report information file.

To solve the above described problem, the invention claimed in the claim 6 is a support system as claimed in the claim 5, wherein
an introducer report-browse page file is memorized in the storage of the server to display contents of the report information file for browsing on the introducer computers,
on the server are implemented
   an introducer report-browse program to readout one or more introduction reports for one of the introducers from the report information file when the introducer has made an access by the introducer computer,
   a receipt confirmation register program to record and register receipt confirmation in the report information file,
the introducer report-browse page file is to display a receipt confirmation inputbox in addition to the settlement for each introduction report,
the receipt confirmation register program is to be executed when receipt confirmation is input in one or more receipt confirmation inputboxes in the introducer report-browse page file, after the introducer report-browse page file with the one or more introduction reports laid in is transmitted to the introducer computer and displayed thereon, and is to record and register the receipt confirmation for the one or more introduction reports, for which the input has been done, in the report information file.

To solve the above described problem, the invention claimed in the claim 7 is a support system as claimed in the claim 3, wherein
an item information modification page file to make information input to modify the item information recorded in the item information file,
on the server is implemented an item information update program to record the modified item information and update the item information file when the modified item information is input and submitted from one of the introducer computers on which the item information modification page has been displayed, and
in the item information recorded in the report information file, the reward and payment condition for each item are not linked to the reward and payment condition in the item information in the item information file respectively so as not to be modified even when the item information file is updated.

To solve the above described problem, the invention claimed in the claim 8 is a support system as claimed in the claim 1, 2, 3, 4, 5, 6 or 7; wherein
the storage of the server memorizes an introducer-evaluation displaying page file;
on the server is implemented an introducer-evaluation browse program; and
the introducer-evaluation browse program is programmed so as to transmit the number of introduction reports, for which one of the introducers has made submissions of introduction reports and rewards have been paid, to the introducee computers, the number being laid in the introducer-evaluation browse page file as evaluation information of the introducer.

To solve the above described problem, the invention claimed in the claim 9 is a support system as claimed in the claim 1, 2, 3, 4, 5, 6, 7 or 8; wherein
the storage of the server memorizes an introducee-evaluation browse page file;
on the server is implemented an introducee-evaluation browse program; and
the introducee-evaluation browse program is programmed so as to transmit the number of introduction reports, for which items are recorded as those merchandised by one of the introducees and for which rewards have been paid, to the introducer computers, the number being laid in the introducee-evaluation browse page file and transmitted as evaluation information of the introducee to the introducer computers.

### Effect of the Invention

By the invention claimed in claim 1, as described later, the introducees can utilize the introduction reports in paying the rewards to the introducers because the introduction reports are forwarded to the introducee computers together with the introducer information.

By the invention claimed in claim 3 additionally, the system is made useful to prevent disputes because the introduction reports are recorded in the report information file.

By the invention claimed in claim 4 additionally, the introducees can catch the introduction reports even if those are overlooked when forwarded by the forwarding program, because the introducees can browse contents of the report information file.

By the invention claimed in claim 5 additionally, the system is useful for the introducers in confirming payments of the rewards, because settlement is recorded in the report information file and the introducers can browse it.

By the invention claimed in claim 6 additionally, the system is made more useful in preventing disputes on reward payments, because the introducees can confirm that the introducers have received rewards.

By the invention claimed in claim 7 additionally, the system is made much convenient in that the introducers do not need to confirm each modification for further agreements, because the item information recorded in the report information file is not modified even when the item information file is updated.

By the invention claimed in claim 8 additionally, the system is made preferable in that the introducees can judge reliability of the introduction reports submitted by the introducers to some extent, because the introducees can browse evaluation information on the introducers.

By the invention claimed in the claim 9 additionally, the system is made preferable in that the introducers can judge to some extent beforehand whether the rewards are paid without fail, because the introducers can browse evaluation information on the introducees.

### BRIEF DESCRIPTION OF DRAWINGS

FIG. 1 schematically shows a customer introduction support system as an embodiment of the invention.

FIG. 2 schematically shows contents of an introducee member information file as an example.

FIG. 3 schematically shows contents of an introducer member information file as an example.

FIG. 4 schematically shows contents of an item information file as an example.

FIG. 5 schematically shows an item search page as an example.

FIG. 6 schematically shows an item information browse page as an example where a category has been selected.

FIG. 7 schematically shows a detailed information browse page for an item as an example.

FIG. 8 schematically shows a member top page as an example.

FIG. 9 schematically shows an item information input page as an example.

FIG. 10 schematically shows an introducee mypage for an introducee as an example.

FIG. 11 schematically shows an item information modification page for an item as an example.

FIG. 12 schematically shows an item information browse page as an example after an introducer membership login has been done.

FIG. 13 schematically shows an report submission page as an example.

FIG. 14 schematically shows contents of a report information file as an example.

FIG. 15 schematically shows the flowchart of a whole report submission program including a forwarding program.

FIG. 16 schematically shows an E-mail created and forwarded by the forwarding program as an example.

FIG. 17 schematically shows an introducer report-browse page for an introducer as an example.

FIG. 18 schematically shows a reward claim page for an item as an example.

FIG. 19 schematically shows a reward bill sent for an item as an example.

FIG. 20 schematically shows an introducee report-browse page as an example.

FIG. 21 schematically shows a detailed introducer information browse page as an example.

FIG. 22 schematically shows an introducer-evaluation browse page as an example.

### BEST MODE FOR CARRYING OUT THE INVENTION

The best mode for carrying out the invention, which is referred as “embodiment” in this specification, will be described next.

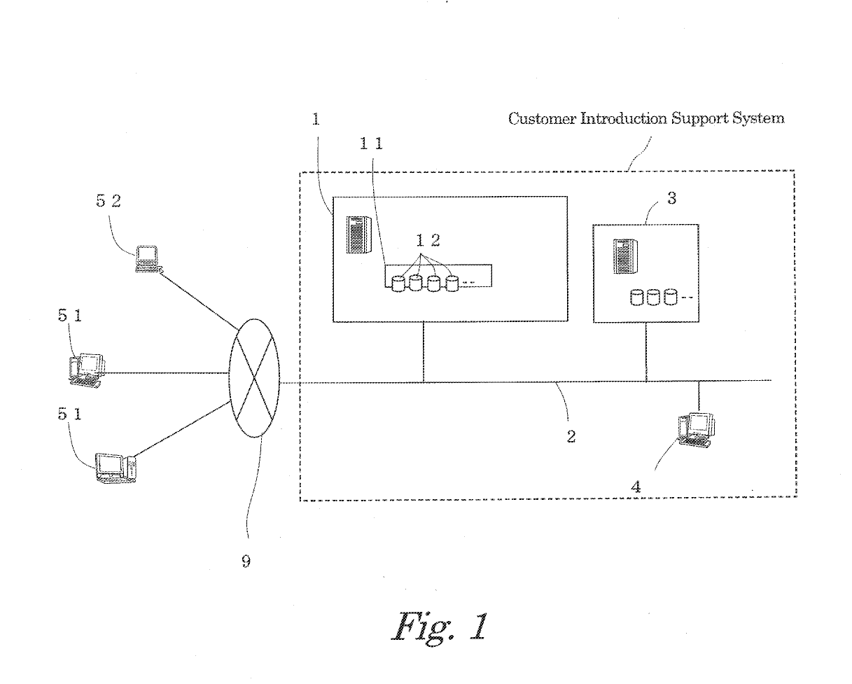

FIG. 1 schematically shows a customer introduction support system as an embodiment of the invention. The system shown in FIG. 1 comprises a server (web server) 1 capable of being accessed by client computers via the Internet 9, and a storage server 3 and administration client computer 4 both connected to the web server 1 via an intranet 2.

Some kinds of programs are implemented on the web server 1. One of them is a web service program 11 to transmit web page files 12 responding to accesses from client computers. Because any commercially available program such as IIS (Internet Information Service) of Microsoft Corporation can be implemented as the web service program 11, its detailed description is omitted. “Implementation” means realizing a function by providing a program on a server.

The web server 1 is supposed to be accessed from client computers 51 handled by introducers, hereinafter referred as “introducer computers”, and other client computers 52 handled by introducees, hereinafter referred as “introducee computers”, via the Internet 9. The computers 51, 52 may be information terminals such as cellular phones and PDA instead of kinds of personal computers.

The web server 1 comprises a storage, which memorizes kinds of files such as webpage files 12 for input and browse of information. The storage may be a hard disk or memory device.

One of the webpage files 12 is to display a top page. Registration has been done on a search engine system so that the top page can be listed in search results by terms such as “customer”, “introduction” and “reward”.

Considering the situation where a person intends to introduce an item (introducee's item) to a third party (customer), the system presents services of providing information of the item for the introducer, and providing an report of introduction, which is necessary in paying the reward, for the introducee. Membership registration is needed both for introducers and introducees to receive these services.

Procedure for the membership registration differs a little between the introducers and the introducees. The introducees need to make contracts with an operating company of this system. Membership registration is applied by sending an application document for receiving the services to the operating company.

A button to download a file (e.g., pdf file) is provided together with description on the services in the top page. An introducee desiring to receive the services makes an application by downloading the file of the application document, printing out it and putting a signature thereon.

It is the pay membership for the introducees. It can charge, for example, a fee for the membership itself (i.e., fee per a member ID issue) and another fee for each item register (i.e., fee per an item ID issue). An introducee makes an application of registration, agreeing these fees.

The operating company issues a member ID (i.e., introducee member ID) after confirming a payment of the fee. The member ID may be issued before confirming the payment. The application document for the introducee membership includes the statement of the agreement that the introducee shall pay a reward set forth by the introducee him/herself or themselves when an introduction successfully satisfies a condition set forth by the introducee him/herself or themselves. The services are provided under the agreement by the introducee regarding this point. To successfully satisfy the payment condition means that an act defined by the introducee has been successfully done by a party introduced to. Although this is typically that the party introduced to buys the introduced item, there may be another case.

On the other hand, no such rigid procedure as the above is required for the introducers. Applications on the website are enough for them. A membership register button for the introducers is provided in the top page. By clicking it, a membership is registered. The introducee membership registration may be enabled on the web site as well.

The information provided in applying the membership registration as described is recorded in some database files memorized in the storage of the web server 1. That is, an introducee member information file and an introducer member information file are memorized in the storage on the web server 1.

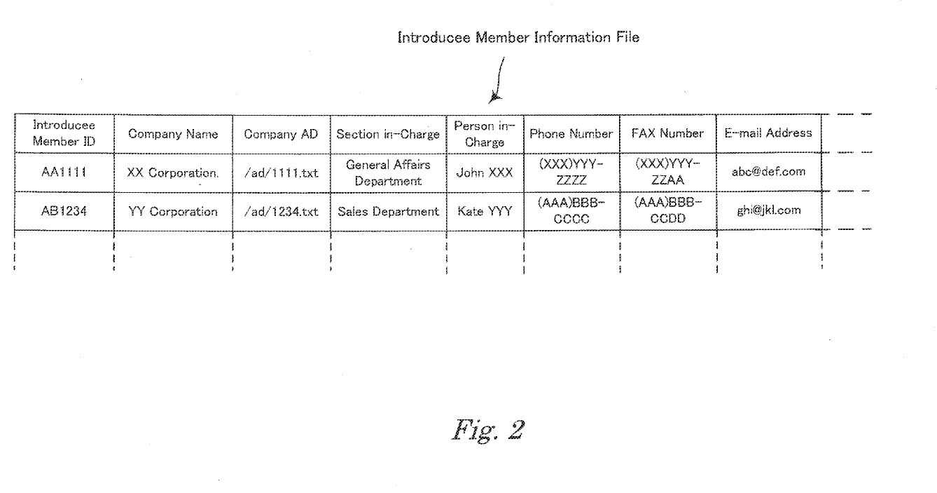

FIG. 2 schematically shows the contents of the introducee member information file as an example. As shown in FIG. 2, the introducee member information file is composed of many records having fields of “Company Name”, “Company AD”, “Section in-charge”, “Person in-charge”, “Phone Number” and so on. “Company AD” is the field where a name and path of a file are recorded. In this file, text information is recorded to advertise about what company it is. This file is hereinafter referred as “company AD file”. A staff of the operating company accesses to the storage server 3 by handling the administration client 4, and records such information in the introducee member information file.

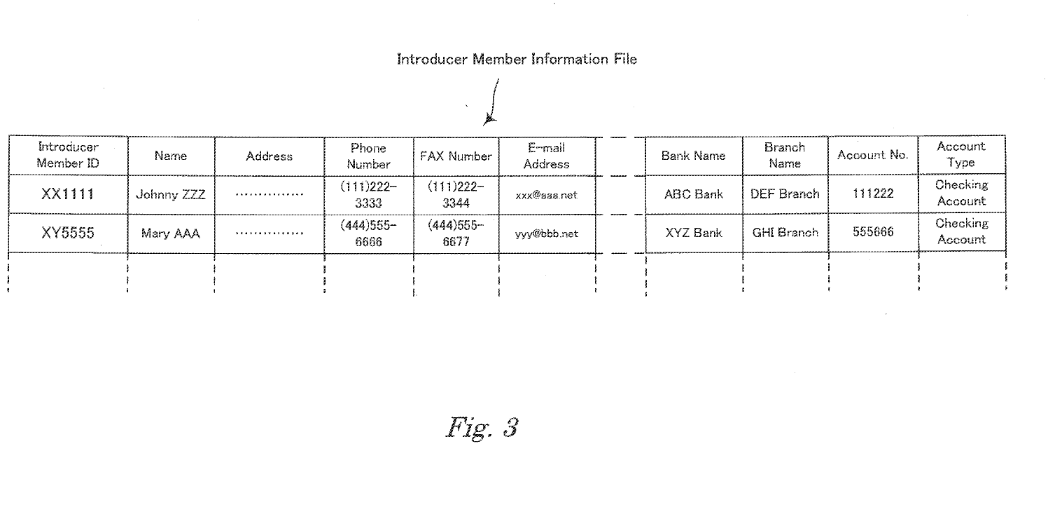

FIG. 3 schematically shows the contents of the introducer member information file as an example. In the introducer member information file, as shown in FIG. 3, pieces of information necessary in paying rewards, such as “Bank Name”, “Account Type” and “Account Number”, are recorded in addition to personal information such as “Name” and “Address”. Recording of the information into the introducer member information file is done by clicking an introducer membership register button provided in the top page, and inputting and submitting each piece of the information. Detailed description about those points is omitted because it is basically the same as in popular websites doing membership registrations.

The web server 1 is commonly used as authentication server. The introducer computers 51 and introducee computer 52 make logins by sending the member ID and passwords, and browse pages for members only. Detailed description about those points is also omitted because it is enabled by implementing a commercially available web service program.

One of services presented by this website is, first, to carry information of items, which introductions are wanted by the introducees, and to make it browsed publicly.

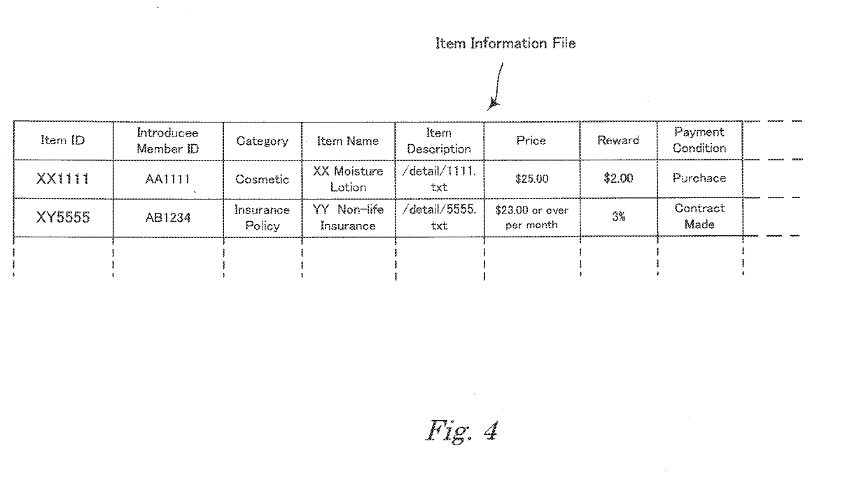

More concretely, the storage memorizes an item information file in which item information is recorded and registered. The item information includes information of the introducees and information about the items which are merchandised by the introducees. FIG. 4 schematically shows the contents of the item information file as an example. The item information file is the database file, in which many records having fields of “Item ID”, “Introducee Member ID”, “Item Category”, “Item Name”, “Item Description” “Price”, “Reward”, “Payment Condition” and so on are recorded. Item descriptions are recorded in other files, considering largeness of the data size. A file name and path for each item are recorded in the field “Item Description” in each record. The files in which the description of the items are recorded are hereinafter referred as “item description files”.

The contents of the item information file are made available for public, including the introducers having made the membership registrations, to browse. This is under consideration that browsing itself may be open to persons not having memberships as introducers because presentation of the item information itself can be sale promotions.

A link button to browse the item information (hereinafter referred as “information browse button”) is provided on the top page. In this embodiment it is supposed that information of lots of the items is registered. The information browse button is linked to a page for searching the item information (hereinafter referred as “item search page”) to browse only items of an intended category. An HTML file for the item search page is provided in the storage of the web server 1. This page is displayed by clicking the information browse button.

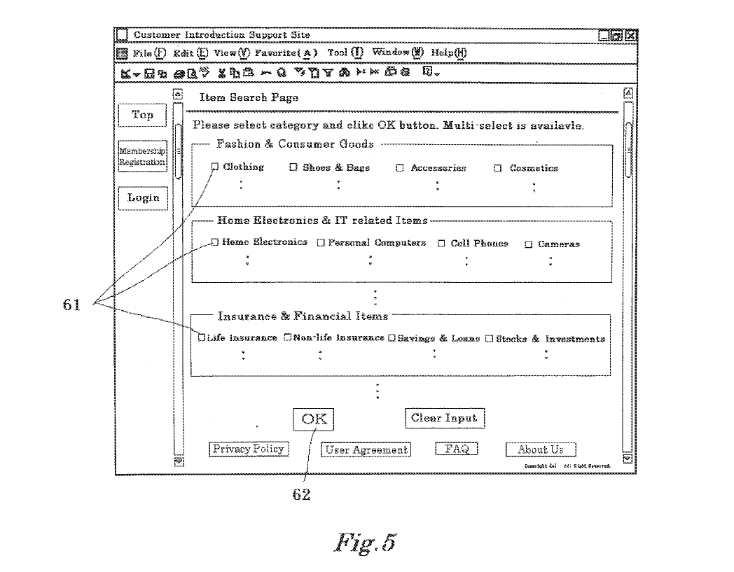

FIG. 5 schematically shows an item search page as an example. As shown in FIG. 5, the item search page has a list of item categories for which checkboxes 61 are provided respectively. An OK button 62 is provided in the bottom of the item search page. A command to start an item information browse program is embedded in the OK button 62. This command starts the program, passing category of which checkbox is checked as argument thereto.

The item information browse program is programmed so as to search the item information file by category as search key, readout all information of the correspond records, lay them in the item information browse page file and transmit it to an introducer computer 51 having made an access. Instead of the example shown in FIG. 5, the item search page may have a hierarchical menu.

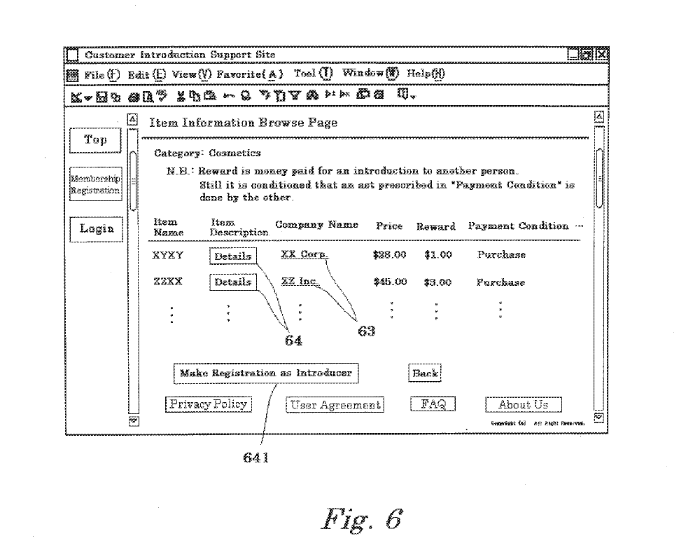

FIG. 6 schematically shows an item information browse page as an example where a category is selected. As shown in FIG. 6, the item information browse page displays item name, company name, price, reward, payment condition and so on for each item. The item information browse program searches the introducee member information file by the introducee member ID as search key, which is readout from the item information file, acquires the company name, and lays it in the item information browse page.

The item information browse program lays letters of each company name as a command button 63. A command to start a program to display detailed information of the company is embedded in each command button 63. This program is to transmit the contents of the introducee member information file for the company.

As shown in FIG. 6, the item information browse page displays information on each item in each line. A command button 64 titled “Details” (hereinafter referred as “detailing button”) is provided in each line. Another button 641 titled “register a membership as introducer” (hereinafter referred as “membership register button”) is provided at the bottom of the item information browse page.

The detailing button 64 is to display the contents of the item description file for the item on the introducer computer 51. A detailed information transmission program is implemented on the web server 1, and a detailed information browse page file is memorized in the storage. The detailing button 64 starts the detailed information transmission program, making the item ID for the item shown at the line as argument. The detailed information transmission program is programmed so as to search the item information file by the item ID as search key, readout information of the field “Item Description”, and acquire the contents of the item information file according to it. In addition, the program is to search the introducee member information file by the introducee member ID as search key, readouts the field “Company AD”, and acquires the contents of the company AD file according to it. Then the program is to lay the acquired information in the detailed information browse file, and transmit it to the introducer computer having made the access.

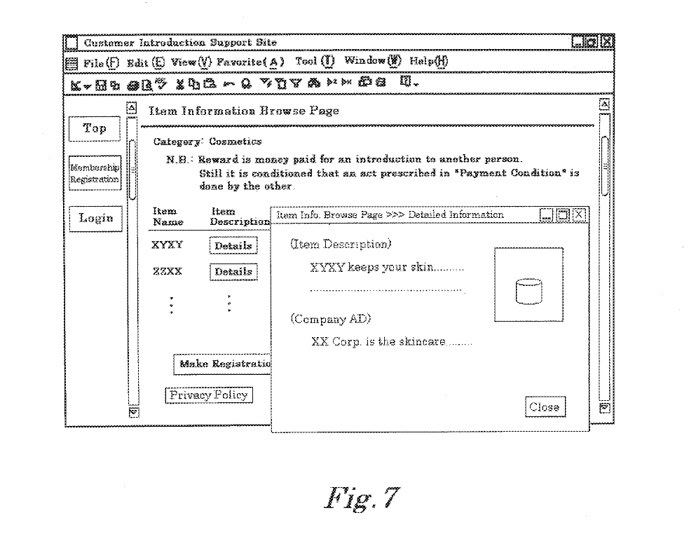

FIG. 7 schematically shows an detailed information browse page for an item as an example. As shown in FIG. 7, the detailed information browse page displays the information of “Item Description” and “Company ID” in addition to the information displayed in the item information browse page shown in FIG. 5. An introducer membership registration would be supposedly done by clicking the membership register button 641 if a person browsing these pages wishes to be registered as introducer and get a reward.

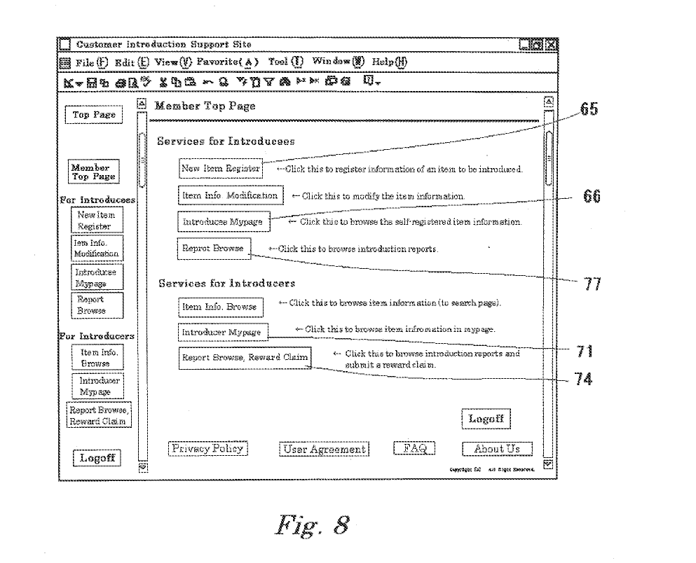

Services only for the registered members will be described next. FIG. 8 schematically shows a member top page as an example, which is displayed after a login.

Contents of this website are divided into two different kinds of services. One is for the introducees, and the other one is for the introducers. Link buttons and/or command buttons for each page to present each kind of services are provided in the member top page.

For the introducees, the website presents a new-item registration service, item information modification service, introducee mypage service (i.e., browsing information of only the self-registered items) and so on. A new-item register button 65 and introducee mypage button 66 are provided in the member top page.

For the introducers, the website presents an item information browse service, introducer mypage service (i.e., registration of selected items for browsing in a later access) and so on.

What is primary in the services for the introducees is to register the item information in the item information file. This service will be described in detail as follows.

The storage of the web server 1 memorizes a web page file to make information of an item, which is desired to be introduced, input at an introducee computer 52. This file is hereinafter referred as “item information input page file”. The web server 1 transmits the item information input page file to the introducee computer 52 according to a transmission request therefrom.

The storage of the web server 1 memorizes a page file for a login window. An introducee displays the login window on the introducee computer 52 and makes a login by inputting the member ID and password. A command to start a transmission program of the item information input page file is embedded in the new-item register button 65.

The web server 1 temporarily stores the member ID input in the login to a memory variable such as session variable. The transmission program of the item information input page file is programmed so as to search the introducee member information file by the member ID as search key, acquire information of the introducee such as the field “Company Name”, lay it in the item information input page file and transmit it to the introducee computer 52 having made the access.

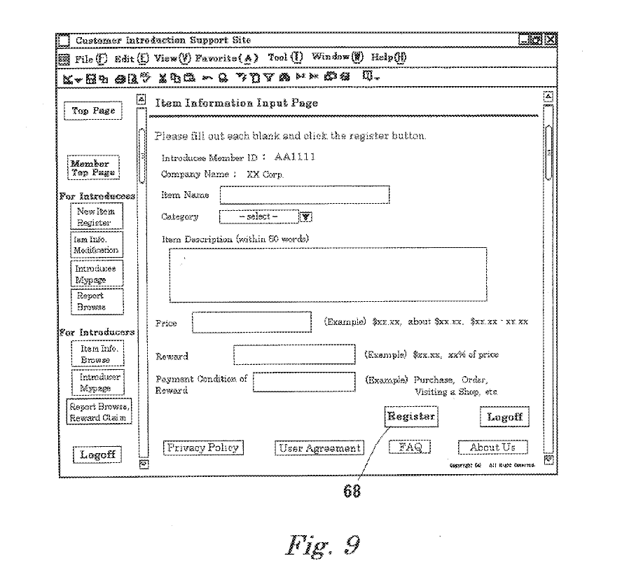

FIG. 9 schematically shows an item information input page as an example. As shown in FIG. 9, the item information input page has inputboxes for category, item name, item description, price, reward, payment condition and so on. The inputbox for category is a combobox (pull-down list) in this example.

A register button 68 is provided in the item information input page. A command to start an item information register program is embedded in the register button 68. The item information register program is programmed so as to submit each piece of the information input in each box and the member ID stored in the memory variable to the storage server 3, and record them in a newly added record in the item information file. Item ID is automatically created on the program and recorded.

For the introducers, on the other hand, the system of this embodiment is capable of presenting a browsing service of the self-registered item information for confirmation, and a real-time modifying service of the item information.

As shown in FIG. 8, a command button 66 titled “Introducee Mypage” (hereinafter, “introducee mypage button”) is provided in the member top page. An introducee mypage program is implemented on the web server 1. A command to start the introducee mypage program is embedded in the introducee mypage button 66 in the member top page. An introducee mypage file is memorized in the storage of the web server 1. The introducee mypage button 66 passes the member ID (i.e., introducee member ID), which has been stored in the login, to the introducee mypage program as argument.

The introducee mypage program is programmed so as to search the item information file by the passed member ID as search key, and readout all information of the record(s) where the member ID matches. The program is also programmed so as to lay all the readout information in the introducee mypage file and transmit it to the introducee computer 52 having made the access.

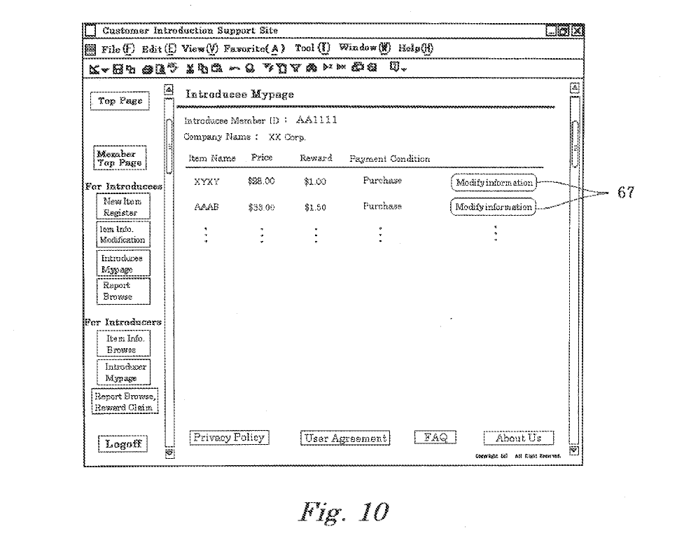

FIG. 10 schematically shows an introducee mypage for an introducee as an example. As shown in FIG. 10, all the item information which the introducee has registered is displayed as a list. The list includes “Item Name”, “Price”, “Reward”, “Payment Condition” and so on.

As shown in FIG. 10, in addition, a command button 67 titled “modify information” (hereinafter, “modification button”) is provided in each line of the list. The storage of the web server 1 memorizes an item information modification page file. A transmission program of this page file is implemented on the web server 1. In each line, the item ID for each item thereof is embedded in each modification button 67. When a modification button 67 is clicked, the transmission program starts as the item ID is passed as argument. The transmission program is programmed so as to search the item information file by the passed item ID as search key, lay information of each field of the matching record in the item information modification page file, and transmit it.

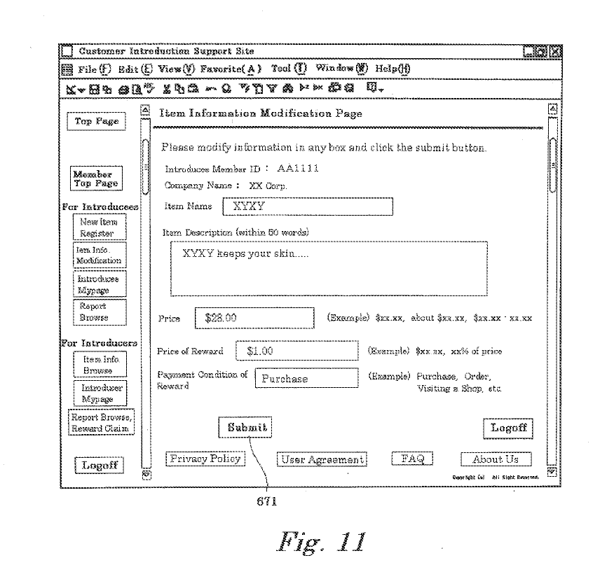

FIG. 11 schematically shows an item information modification page for an item as an example. As shown in FIG. 11, each modification inputbox and a submission button 671 are provided in the item information modification page. An update program is implemented so as to submit the modified information to the storage server 3 via the web server 1, record it in the field(s) of the corresponding record, and update the file, when the submission button 671 is clicked.

Only for the members registered as introducers, services of mypage registration, introduction report submission, reward claiming submission, and receipt confirmation submission are presented. First, the mypage registration will be described in detail.

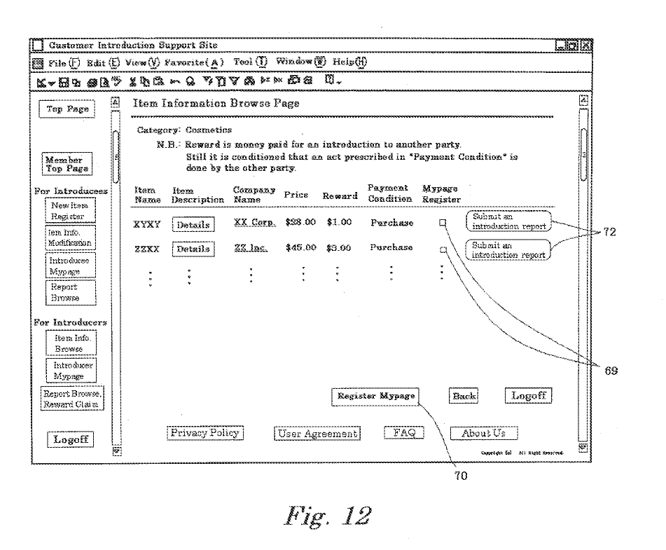

The mypage registration is the service to enable registration of one or more items freely selected from items shown in the item information browse page, and display of only the selected item(s). FIG. 12 schematically shows an item information browse page as an example which is displayed after an introducer membership login. Although the item information browse page shown in FIG. 12 is almost the same as in FIG. 6, a row titled “mypage registration” is provided. In this row, checkboxes 69 (hereinafter, “mypage register checkboxes”) are provided. A button 70 titled “register mypage” (hereinafter, “mypage register button”) is provided in the bottom of the item information browse page.

An introducer mypage register program is implemented on the web server 1. A command to start the introducer mypage register program is embedded in the mypage register button 70. The storage of the web server 1 memorizes an introducer mypage information file where the information of the registered item for each introducer is recorded. The item ID of the items selected by each introducer is recorded for each introducer respectively in the introducer mypage information file.

The mypage register button 70 passes the item ID of the items for which mypage register checkboxes 69 are checked and the member ID input in the login to the introducer mypage register program. The mypage register program is programmed so as to record those pieces of information in the introducer mypage information file.

By the mypage registration as described, it is enabled to browse only the information of registered items in the next access. That is, a mypage browse program is implemented on the web server 1, and a button 71 titled “Introducer Mypage” is provided as a link button to the mypage service for the introducers in the member top page. When this button 71 is clicked, the mypage browse program starts, searching the introducer mypage information file by the member ID as search key and reading out all item ID recorded therein. Then the program is to search the item information file by each readout item ID as search key, readout each pieces of the item information, lay them in the item information browse page, and make it displayed.

The introduction report transmission service will be described next.

A command button 72 titled “Submit an introduction report” (hereinafter, “report button”) is provided in each line of the list in the item information browse page shown in FIG. 12. Although not shown, the item information browse page is the same when it is transmitted via the mypage browse. Each report button 72 is supposed to be clicked when each item shown in each line has been actually introduced to a third party (e.g., friend).

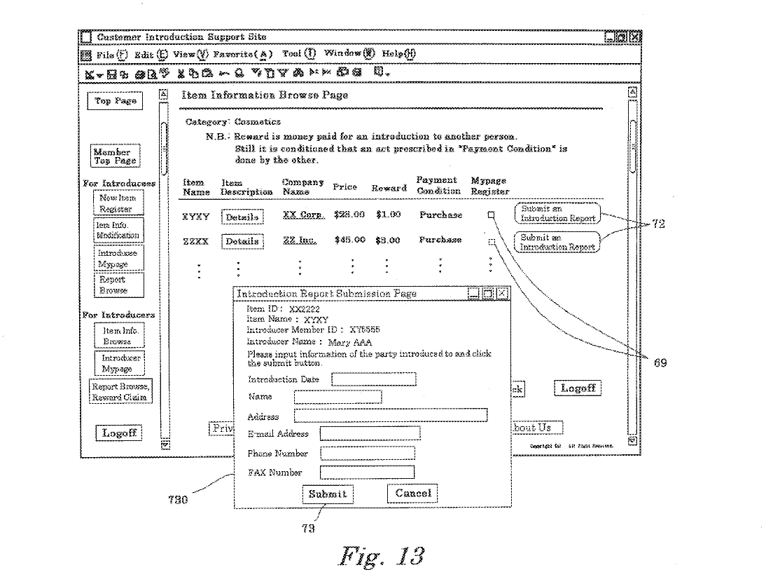

More concretely, a report submission program is implemented on the web server 1. A report submission page file is memorized in the storage thereof. FIG. 13 schematically shows a report submission page as an example. When one of the report buttons 72 in FIG. 12 is clicked, the page file is transmitted to an introducer computer 51, displaying the report submission page shown in FIG. 13.

As shown in FIG. 13, inputboxes for personal information of a third party introduced to, such as “Name”, “Address”, “Phone Number”, “E-mail Address” and so on, are provided in the report submission page 730. A submission button 73 is provided at the bottom thereof.

A command to start the report submission program is embedded in the submission button 73. This command is to pass each piece of information input in each inputbox, the item ID and the member ID (i.e., introducer member ID) stored in the memory variable to the report submission program. Although the item ID is not displayed in the report submission page 730, it is embedded in the submission button 73.

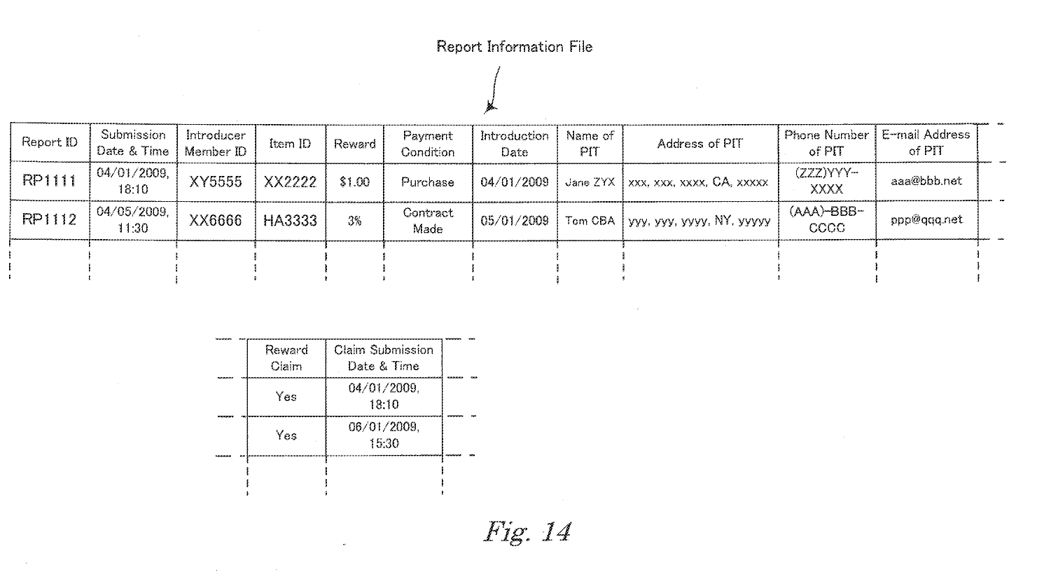

A report information file is memorized in the storage server 3. The report information file is the database file where information on introductions reported by the introducers is recorded. FIG. 14 schematically shows a report information file as an example.

As shown in FIG. 14, the report information file is composed of many records having fields of “Report ID”, “Submission Date & Time”, “Introducer Member ID”, “Item ID”, “Reward”, “Payment Condition”, “Introduction Date”, “Name of PIT”, “Address of PIT”, “Phone Number of PIT”, “E-mail Address of PIT”, and so on. PIT stands for “Party Introduced To” in the specification and drawings.

The report submission program is programmed so as to submit the passed pieces of information to the storage server 3, and record them in a newly added record in the report information file. In this, the program is to search the item information file by the passed item ID as search key, and readout reward and payment condition from the matching record, and then record them in the newly added record in the report information file. The report ID is automatically created and recorded by the program.

A forwarding program is implemented on the web server 1. The forwarding program is to forward each introduction report to each introducee computer 52 when it is submitted from each introducer computer by the report submission program. In this embodiment, the forwarding program is implemented as a subprogram of the report submission program. The report submission program is programmed so as to execute the forwarding program after recording the submitted pieces of information in the report information file.

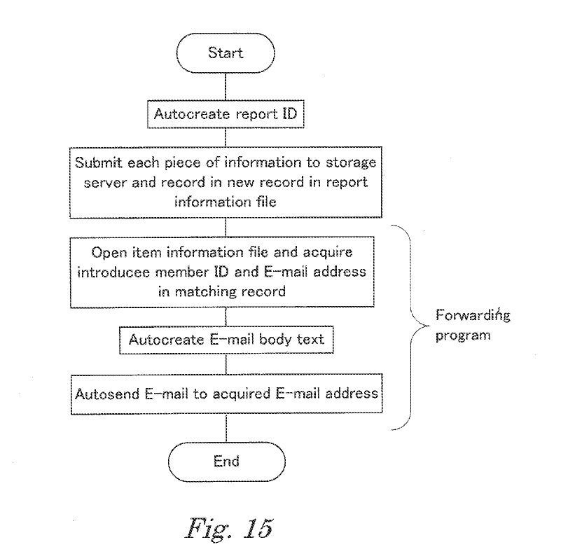

In this embodiment, the forwarding program is to forward each piece of information in form of an E-mail. FIG. 15 schematically shows the whole flowchart of the report submission program including the forwarding program.

As shown in FIG. 15, the forwarding program is programmed so as to search the item information file by the passed item ID as search key, and acquire the introducee member ID and E-mail address from the matching record. The program is also programmed so as to create an E-mail body as each passed piece of information is laid in, and forward it to the acquired E-mail address. The automatic creation and automatic sending of E-mail are enabled by functions of the web service program 11. For example, IIS of Microsoft Corporation includes the SMTP service, which enables an imaginary SMTP for these functions. The forwarding program is programmed so as to record the submission date and time in the field “submission date and time” in the report information file.

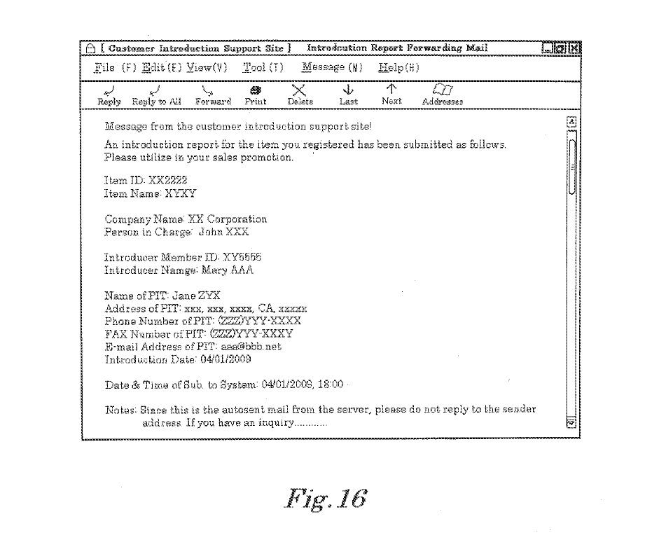

FIG. 16 schematically shows an E-mail created and forwarded by the forwarding program as an example. As shown in FIG. 16, the forwarded E-mail has the list of item ID, item name, price, company name, name of person in charge, introducer name, introducer member ID, name of party introduced to, address of party introduced to, E-mail address of party introduced to, introduction date, and so on.

As other services for the introducers, this website is capable of transmitting a list of introduction reports which an introducer has submitted, and making information on a reward claim submitted for a specified introduction report. These points will be described as follows.

As shown in FIG. 8, a command button 74 titled “report browse, reward claim” is provided in the member top page. The command button 74 is hereinafter referred as “introducer report-browse button”. An introducer report-browse page file is memorized in the storage of the web server 1. A transmission program of this page file is implemented thereon.

When the introducer report-browse button 74 is clicked, the transmission program starts as the introducer member ID stored in the login is passed as argument. The transmission program is to search the report information file, readout all pieces of information of records where the introducer member ID matches, lay them in the introducer report-browse page, and transmit it.

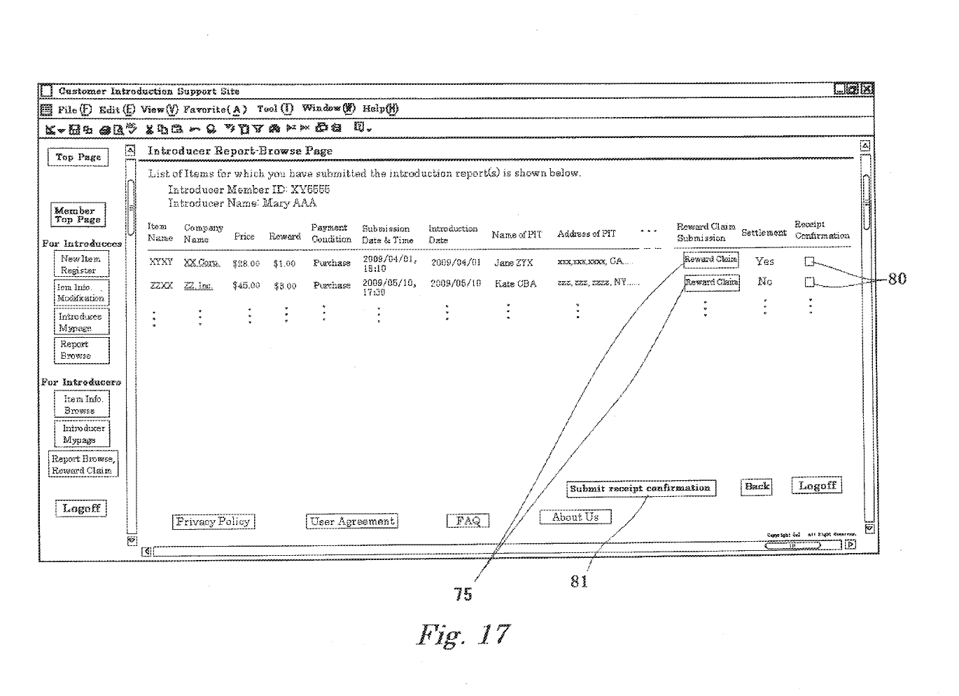

FIG. 17 schematically shows an introducer report-browse page for an introducer as an example. Although the introducer report-browse page shown in FIG. 17 is almost the same as the item information browse page in FIG. 12, a row “Submission Date & Time” and the row of command buttons 75 titled “reward claim” are provided in the list. The command buttons 75 are hereinafter referred as “claim buttons”.

A reward claim submission program is implemented on the web server 1. A reward claim page file is memorized in the storage thereof. A command to start the reward claim submission program is embedded in each claim button 75. Each claim button 75 starts the reward claim submission program, passing the report ID as argument. The reward claim submission program is programmed so as to search the report information file by the passed report ID as search key, readout information from each field of the matching record, lay it in the reward claim page file, and transmit it.

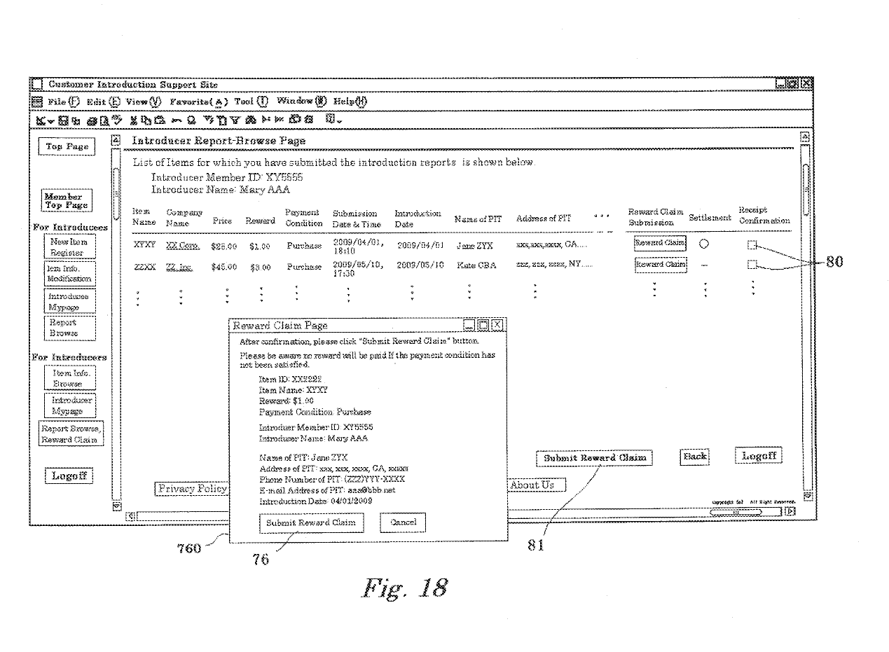

FIG. 18 schematically shows the reward claim page for an item as an example. As shown in FIG. 18, the reward claim page 760 displays detailed information on a selected introduction report for confirmation, and has a command button 76 titled “reward claim submission” (hereinafter, “claim submission button”). A claim information processing program is implemented on the web server 1 to record the submitted claim information in the report information file and forward it to the introducee in form of a bill.

The claim submission button 76 is to start the claim information processing program, making the report ID for the displayed introduction report as argument. The claim information processing program is programmed so as to search the report information file by the report ID as search key, record the true value in the field “Reward Claim” of the matching record, acquire the submission date and time from the session variable of HTTP, and record them in the field “Claim Submission Date & Time”.

The claim information processing program is then to create a reward bill automatically. A form file for reward bills is memorized in the web server 1. The claim information processing program is to readout required pieces of information from the record, lay them in the form file, and temporarily memorize the updated form file in a storage (e.g., memory), automatically creating a filename.

The claim information processing program is then to readout the field “Introducee E-mail Address” of the record in the report information file, and send the reward bill (i.e., the updated form file) to this address as an attached file. The mail body is also created appropriately.

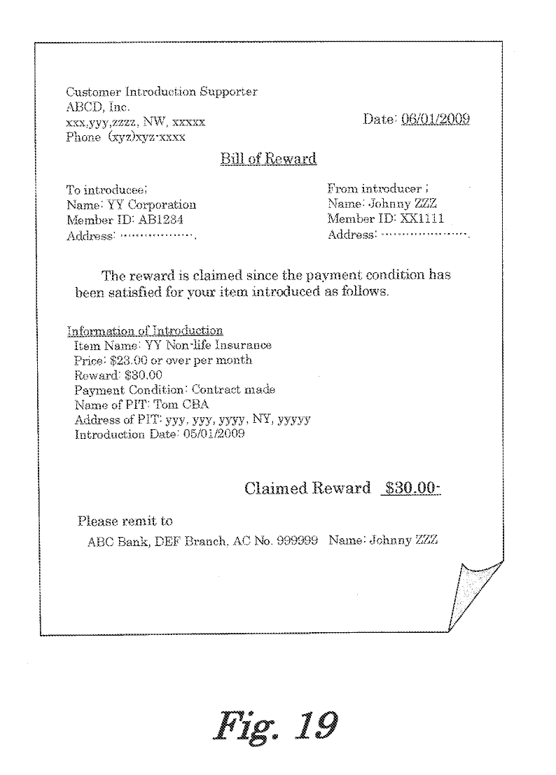

FIG. 19 schematically shows a reward bill sent for an item as an example. As shown in FIG. 19, the reward bill, which form is almost the same as regular bills, is one where an introducer charges an introducee a reward for success of an introduction. All pieces of the information are recorded in any file on the web server 1. Information not recorded in the reward claim information file is acquired by searching the member information files and item information file.

The each piece of information concerning to introduction reports as described is capable of being browsed, as the service for introducees. This point will be described as follows.

A command button 77 titled “report browse”, which is hereinafter referred as “introducee report-browse button”, is provided in the member top page (FIG. 8). An introducee report-browse program is implemented on the web server 1, and an introducee report-browse page file is memorized in the storage thereof.

The introducee report-browse button 77 is to start the introducee report-browse program, passing the introducee member ID stored in a login as argument. The introducee report-browse program is programmed so as to search the report information file by the passed introducee member ID as search key, readout all information of the records where the introducee member ID matches, lay it in the introducee report-browse page file, and transmit it to the introducee computer 52 having made the access.

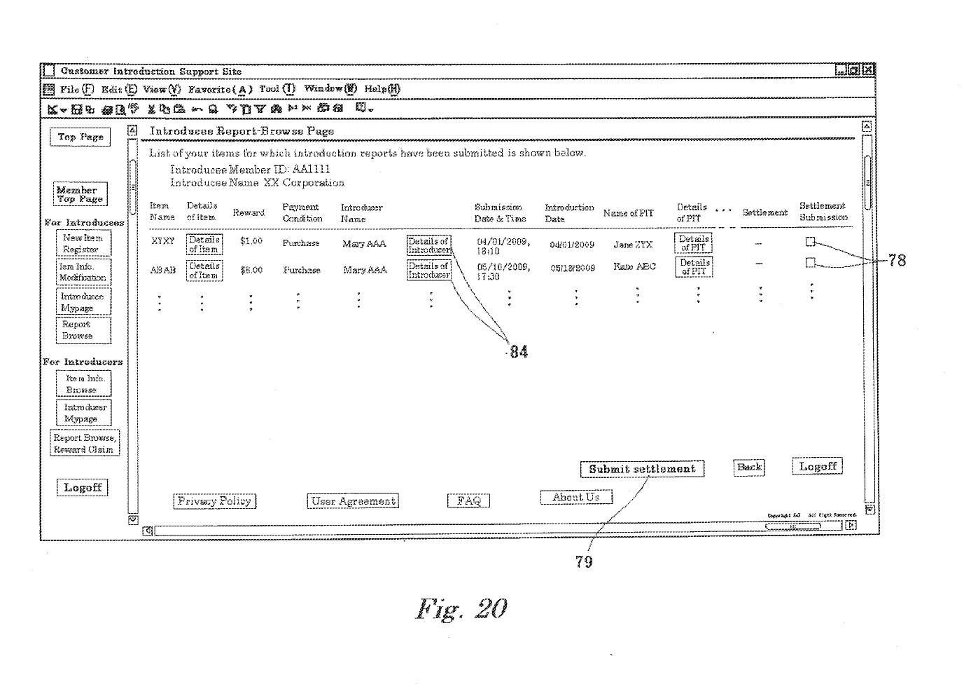

FIG. 20 schematically shows an introducee report-browse page as an example. As shown in FIG. 20, all pieces of information on items are displayed as a list. The items are those which the introducee has registered, and for which introduction reports are registered. This list has rows of “Item Name”, “Details of Item”, “Introducer Name”, “Details of Introducer”, “Name of PIT” “Details of PIT”, “Submission Date & Time”, and so on.

In the rows of “Item Name”, “Introducer Name”, “Name of PIT” and “Submission Date & Time”, the same information as in the report information file is displayed. In the rows of “Details of Item”, “Details of Introducer” and “Details of PIT”, command buttons are provided respectively. In each command button of “Details of Item”, the item ID for each introduction report shown in each line is embedded. A command to start a displaying program is also embedded in each command button “Details of Item”. This displaying program is to search the item information file by the item ID as search key, and display information of the matching record. In each command button 84 of “Details of Introducer”, the introducer member ID corresponding to the introduction report shown in each line is embedded. A command to start a displaying program is also embedded in each command button 84. This displaying program is to search the introducer member information file by the introducer member ID as search key, and display information of the matching record. In each command button of “Details of PIT”, the report ID corresponding to each introduction report shown in each line is embedded. A command to start a displaying program is also embedded in each button “Details of PIT”. This displaying program is to search the report information file by the report ID as search key, acquire information such as name of PIT, address of PIT and E-mail address of PIT, and display it.

As understood from the above description, the pieces of information displayed in the introducee report-browse page shown in FIG. 20 are those which have been transmitted in form of an E-mail. Although the pieces of information are transmitted via the E-mail respectively, the list of those is made browsable so that what introduction reports have been transmitted can be confirmed by a quick look.

As another service for introducees, facts of payments can be submitted to the web server 1 when rewards are actually paid for introductions for which the reward bills have been sent. This point will be described as follows.

As shown in FIG. 20, there is a row titled “Settlement” in the header line in the introducee report-browse page. In each line of the row, a checkbox 78 (hereinafter, “settlement checkbox”) is provided. A command button 79 titled “Submit settlement” (hereinafter, “settlement submission button”) is provided at the bottom of the introducee report-browse page.

A settlement register program is implemented on the web server 1. A command to start this program is embedded in the settlement submission button 79. The settlement submission button 79 is to start the settlement register program, passing the report ID of introduction reports for which settlement checkboxes 78 are checked.

The settlement register program is programmed so as to search the report information file by the report ID as search key, and record the true value in the field “Settlement” of each matching record. As the report ID are passed in order, the settlement register program searches the report information file in order and records the true value in the field “Settlement” in order.

As shown in FIG. 17, on the other hand, there is a row titled “Settlement” in the header line in the introducer report-browse page. In this row, the described information recorded in the report information file is displayed without modification. That is, “Yes” is displayed for the true value, and “No” is displayed for the false value.

Next to the row “Settlement”, there is a row titled “Receipt Confirmation”. A checkbox 80 (hereinafter, “receipt confirmation checkbox”) is provided in each line of this row. A command button 81 titled “Submit receipt confirmation” (hereinafter, “receipt confirmation button”) is provided at the bottom in the introducer report-browse page.

A receipt confirmation register program is implemented on the web server 1. The receipt confirmation register program is to record in the report information file the fact that a payment is confirmed by an introducer. A command to start the receipt confirmation register program is embedded in the receipt confirmation button 81.

The receipt confirmation button 81 is to start the receipt confirmation register program, passing the report ID of the introduction reports for which receipt confirmation checkboxes are checked. The receipt confirmation register program is programmed so as to search the report information file by the passed report ID as search key, and record the true value in the field “Receipt Confirmation” of each matching record. As the report ID of the introduction reports are passed in order, the receipt confirmation register program searches the report information file in order, and records the true value in the field “receipt confirmation” in order.

Operation of the customer introduction support system of this embodiment will be described next.

An introducee browses the top page of this website by chance such as found in a search result at a portal site while accessing the Internet by the introducee computer 52. The introducee has got interested in the services presented on this website, intends to request introduction of an item via this website, and applies a membership registration as introducee.

After confirming a payment of the registration fee, an administrator of the operating company issues a member ID. The introducee displays the login page on the introducee computer 52, and carries out settings such as password to enable logins as introducee.

The introducee also registers information on his/her/their item(s) which are desired to be introduced via the website. That is, after making an access to the web server 1 by handling the introducee computer 52 and making a login, the introducee clicks the new item register button 65 and makes the item information input page file transmitted. Then the introducee inputs each piece of the information, and makes it registered by clicking the new-item register button 65.

On the other hand, an introducer also browses the top page by chance while accessing the Internet. While browsing the item information browse page or another, the introducer has got interested in receiving a reward for introduction of an item to another party, and makes a registration as introducer. The introducer also carries out a password setting by handling the introducer computer 51 to enable logins as introducer. After a login, the introducer browses the item information browse page, and adds checkmarks in the checkboxes 69 for desired items, thereby registering the items in the introducer mypage.

When the introducer has in mind that an item can be introduced to another party (e.g., friend, acquaintance, relative, etc.), the introducer lets the other party know detailed information on the company and detailed information on the item. In this, those pieces of information may be printed out and passed.

The introducer who has done this introduction makes a submission of the introduction report. That is, after accessing the web server 1 by handling the introducer computer 51 and making a login, the introducer displays the introducer mypage. The introducer clicks the report button 72 of the item for which the introduction has been done. By this, the report submission program starts, recording the introduction report in a newly added record in the report information file. Then the forwarding program as the subprogram starts, sending the introduction report via E-mail to the introducee computer 52 for the introducee who has registered the item.

By reading the forwarded E-mail, the introducee notices that his/her/their item has been introduced. Even if the E-mail is overlooked, by accessing the web server 1 and browsing the introducee report-browse page the introducer would notice that the item has been introduced.

By the E-mail or browsing the introducee report-browse page, the introducee acquires detailed information of the party introduced to. The introducee carries out sales activity onto the party introduced to according to the detailed information. For example, a brochure of the item may be sent (via E-mail or postal mail), and/or a sales phone call may be made.

If such sales activity leads to an actual purchase of the item, the introducer would claim the reward because it means his/her/their introduction has succeeded. The introducer makes a login to the website by handling the introducer computer 51, and makes the member top page displayed. Then the introducer clicks the introducer mypage button 66, making the introducer mypage displayed. In the list shown in the introducer mypage, the introducer clicks the claim button 75 in the line showing the introduction report of which introduction has succeeded, thereby making the reward claim page 760 displayed. After confirming the contents of the reward claim page 760, the introducer clicks the claim submission button 76. By this, the claim information processing program starts, registering the claim information in the report information file and sending a reward bill to the introducee computer 52.

The introducee to whom the reward bill has been sent confirms the information stated in the bill such as item, introducer and party introduced to, and then judges the claim is right or not. That is, authenticity of the introduction act is judged. If authentic, the reward would be paid. If not authentic (i.e., the item has not been purchased although the sale activity has been done after the introduction), the introducee would not pay the reward, ignoring the bill.

If the reward is paid, the introducee makes a submission of settlement. That is, the introducee makes a login by handling the introducee computer 52, and makes the introducee report-browse page displayed by clicking the introducee report-browse button 77. In the list shown therein, the introducee adds a checkmark in the checkbox 78 at the line of the introduction report for which the payment has been done, and then clicks the settlement submission button 79. By this, the settlement register program starts, recording the true value in the field “Settlement” of the corresponding record in the report information file.

On the other hand, the introducer who has been paid makes a submission of receipt confirmation. That is, the introducer clicks the introducer report-browse button 74 in the member top page after a login, and makes the introducer report-browse page displayed. In the list shown therein, the introducer clicks the receipt confirmation button 81 at the line of the report information for which the payment has been done. By this, the receipt confirmation register program starts, recording the true value in the field “Receipt Confirmation” of the corresponding record.

As described, the system of this embodiment enables an introducee to register his/her/their own item desired to be introduced, and to make it freely browsed by the introducers. If an introducer introduces the item to a third party, the system makes the introduction report submitted to the web server 1, registers the introduction report on the website, and forwards it instantly to the introducee computer 52. The system also enables the introducer to submit a reward claim to the web server 1 when the introducer makes a success for the introduction, and transmits it in form of a bill to the introducee computer 52 as well as registers it on the website. When the introducee makes a payment, the system makes the settlement submitted to the web server 1, and registers it on the website. The system also makes the receipt confirmation submitted and registers it on the website.

What is important in the described structure and operation of the system is that the fields of “Reward” and “Payment Condition” in the report information file are NOT linked to the fields of “Reward” and “Payment Condition” in the item information file respectively. As described, the information recorded in the fields of “Reward” and “Payment Condition” can be modified when an introducee clicks the submission button 68 after inputting modified information in the item information modification page. Even if any record of an introduction report for the item exists in the report information file at the time of the modification, however, the modification is NOT reflected in the fields of “Reward” and “Payment Condition” thereof. In other words, values of the fields “Reward” and “Payment Condition” of a record in the report information file are fixed at those of the item information file at the time when the record was newly created and registered in the report information file, not being changed even if the values in the item information file are modified afterward. This is because it is recognized that the agreement has been made between the introducer and the introducee about the reward and payment condition at the time when an introduction report has been transmitted by an introducer. This solution makes the system much more convenient because the introducer has no need to confirm and agree any modification of the reward or payment condition even if it is done by the introducee.

Taking some examples of customer introductions supported by the system of this embodiment, items may be not only material (i.e., consumer goods) but may be immaterial, such as financial goods and any kinds of services. For example, the system can be utilized in introducing an automobile trader to a friend considering buying a brand new car, or in introducing a life insurance company to an acquaintance considering purchasing a life insurance policy. Any kinds of contract jobs can be items for this system as well. For example, the system can be utilized for development of products, creation of web pages, industrial design of products, qualified professional jobs such as lawyers, and so on.

In offering such a contract job or buying an item not being commodity, servicers or providers could be all small companies. In many cases, orders might be made not knowing what companies they are. Although in such a case, an order could be made a little more reliably if an introducer exists therebetween.

For a party to be introduced, it is difficult to invest much money for an advertisement if his/her/their business size is small. Therefore, a sale would be promoted hardly only by the advertisement. If the party makes a registration as introducee on this website, he/she/they can acquire information of another party to be introduced to only by paying a small amount of the system usage fee. Therefore, the system could be a strong tool for the sales promotion.

For an introducer, moreover, because a reward is paid if a successful act is done by a friend, acquaintance, relative or another who has been introduced to, it could be a great incentive to the introduction. Because rewards are paid for just introductions, those could be side businesses for salaried workers, bringing expectations of large casual incomes.

In the described embodiment, recordation of introduction reports into the report information file has the same effect as log recordation of information transmissions from introducers to introducees. Contents of the report information file could prove that an introducer actually has submitted an introduction report. Therefore, in case that a dispute arises between an introducer and an introducee (that is, whether information on a party-introduced-to has been presented or not), the contents of the report information file could be a means for solving disputes. The operating company of the system could be a mediator to solve the dispute by managing the report information file properly.

Although purchase of an item is the typical example of the payment condition of the reward, just an order could be a success of introduction in such a case as contract job. In such a case, otherwise, the introduction may be regarded as succeeded when the payment is done after the ordered job has been completed. As another example, if a party-introduced-to visits a sales branch office, or if a party-introduced-to has a business talk with a salesperson, it may be regarded as success of introduction. In such a service as online shopping, furthermore, a membership registration on a website may be regarded as success of introduction. In any cases, an introducee can freely define any act as success of introduction, and record and register execution of it as the payment condition in the item information file.

The system of this embodiment is capable of evaluations both on introducers and on introducees, relating to provision of the services, and capable of making evaluation results browsable. This point will be described as follows.

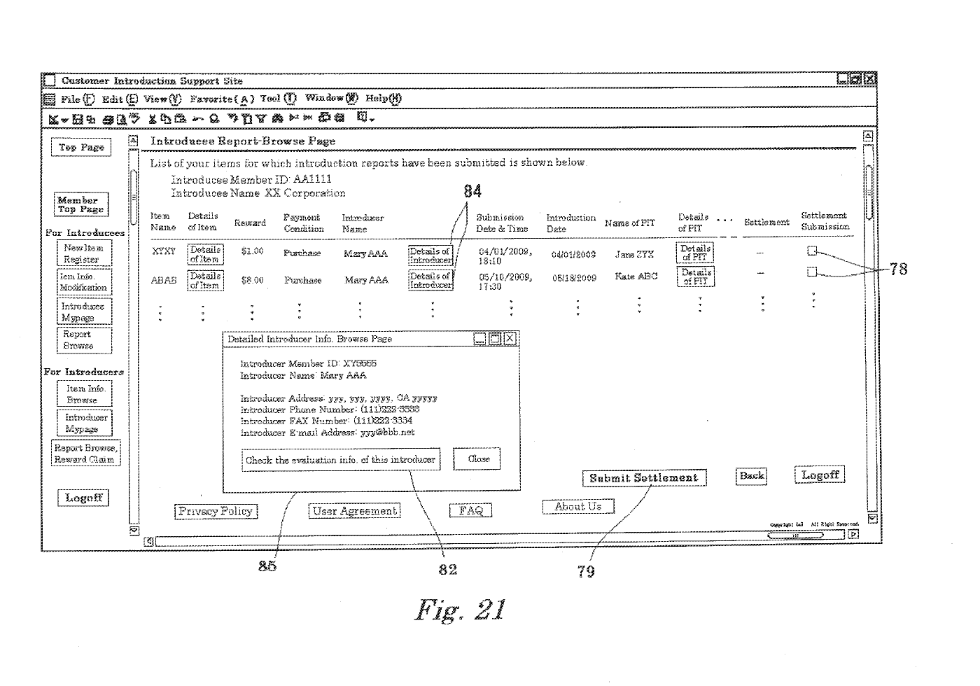

FIG. 21 schematically shows an example of pages when the command button 84 titled “Details of Introducer” is clicked in the introducee report-browse page shown in FIG. 19. This page is hereinafter referred as “detailed introducer information browse page”. As shown in FIG. 21, the detailed introducer information browse page 85, in which detailed information of an introducer is displayed, includes a command button 82 titled “Check the evaluation information of this introducer” (hereinafter, “introducer-evaluation browse button”). An introducer-evaluation browse program is implemented on the web server 1. A command to start this program is embedded in the introducer-evaluation browse button 82. The member ID of the displayed introducer is embedded in the introducer-evaluation browse button 82. The introducer-evaluation browse button 82 passes the introducer member ID to the introducer-evaluation browse program as argument.

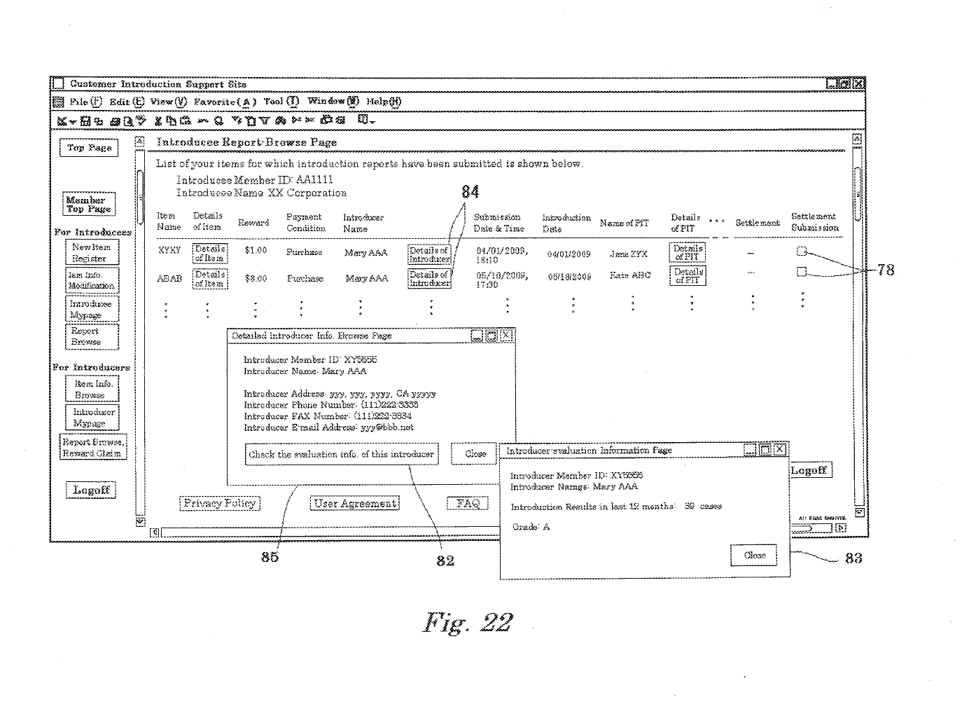

FIG. 22 schematically shows an introducer-evaluation browse page as an example. As shown in FIG. 22, the introducer-evaluation browse page 83 displays the number and evaluation grade on past introduction results (e.g., for last 12 months) for the introducer. The introducer-evaluation browse program is programmed so as to search the report information file by the passed introducer member ID as search key. In this, the number of all records where the true value is recorded in both fields of “settlement” and “Receipt Confirmation” is counted. The introducer-evaluation browse program is also programmed so as to determine the evaluation grade according to a preset criterion, lay it with the counted record number in the introducer-evaluation browse page, and transmit it to the introducee computer 52.

Some different criteria can be employed in determining the evaluation grade. As a simple one, the evaluation grade may be determined according to the number of records (i.e., the number of results). Otherwise, it may be determined weighing the number of disputes on introduction reward. In this case, a field to record the number of disputes is provided in the member information files. The number of disputes which has been learned is input at the administration client computer 4, and recorded in the member information files. Then the evaluation grade is determined considering the number of results and the number of disputes. As a dispute caused by an introducer, there may be the case that the introducer submits an introduction report nevertheless no introduction has been done actually. Otherwise, there may be the case that an introducer submits a reward claim grounding a successful act has been done by a party-introduced-to nevertheless the party has not done any successful act actually. As a dispute caused by an introducee, there may be the case that no reward is paid responding to an introducer's claim nevertheless a successful act has been done properly.

Display of introducee-evaluation information can be almost the same as of the introducer evaluation information as described. For example, the contents of the item description file and company AD file are displayed when a detailing button 64 (FIG. 6) is clicked. In this, a command button titled “Check the evaluation information of this company” may be provided. When this command button is clicked, the evaluation information is readout similarly as for introducers, and transmitted to the introducer computer 51. In determining the evaluation grade of an introducee, the number of cases where no reward has been paid nevertheless successful acts have been done properly is weighed.

In the described embodiment, the sum calculated in a certain period (e.g., monthly) may be claimed to an introducee if a reward for one time introduction is small. In this case, a program is implemented to claim the sum of bills. The program is programmed so as to gather rewards for introduction reports where the same introducer has introduced the same introducee's item(s) for a period, calculate the sum of them, automatically create a bill claiming the sum, and transmit it to the introducee computer 52. The system of this invention may receive accesses via networks other than the Internet.

### POSSIBILITY OF INDUSTRIAL UTILIZATION

As described, the system of this invention is preferably utilized in sales promotions of items by introductions.

### DESCRIPTION OF SYMBOLS

1 web server

2 intranet

3 storage server

4 administration client computer

51 introducer computer

52 introducee computer

9 Internet

1. A support system comprising a server connected both to introducee computers handled by introducees wishing to be introduced to customers, and to introducer computers handled by introducers intending to introduce the introducees to customers; wherein
a storage of the server memorizes
an introducee information file in which information about the introducees is recorded;
an item information file in which information about items merchandised by the introducees is recorded,
an introducer information file in which information about the introducers is recorded including information necessary in paying rewards,
an item information input page file to make the introducee computers input and submit the item information,
an introducer information input page file to make the introducer computers input and submit the introducer information
an item information browse page file to browse the item information recorded in the item information file; and
an report submission page file to make the introducer computers select items and submit to the server introduction reports that introductions have been done for the selected items;
on the server, are implemented
an item information register program to record the item information in the item information file when the item information is submitted from one of the introducee computers on which the item information input page is displayed,
an introducer information register program to record the introducer information in the introducer information file when the introducer information is submitted from one of the introducer computers on which the introducer information input page is displayed,
an item information browse program to readout the item information from the item information file, transmit to one of the introducer computers the item information browse page file with the item information laid in, and make the item information browsed thereon, when an access has been made from the introducer computer,
a report submission program to make the introduction reports submitted from the introducer computers to the server, and
a forwarding program to forward each introduction report to each introducee computer when each introduction report is submitted from each introducer computer by the report submission program;
the item information includes the information about the rewards for introductions of items to third parties and conditions on payments of the rewards;
each introduction report includes item identifying information to identify each item for which each introduction has been done, introducee identifying information to identify each introducee for each item, introducer identifying information to identify each introducer for each introduction, and information about each third party introduced to; the forwarding program is programmed so as to search the introducer information file according to the submitted introducer identifying information, and forward each introduction report with information on each introducer acquired from the introducer information file.

2. A support system as claimed in the claim 1 wherein
E-mail addresses are included in the introducee information recorded in the introducee information file as attentions of the introduction reports, and
the forwarding program is programmed so as to acquire each E-mail address by searching the introducee information file according to the submitted each piece of the introducee identifying information.

3. A support system as claimed in the claim 1 or 2, wherein
an report information file where each of the introduction reports is recorded in form of database is memorized in the storage of the server,
the report submission program is programmed so as to record additionally the introducer information in the report information file when each of the introduction reports is submitted.

4. A support system as claimed in the claim 3, wherein
.the storage of the server memorizes an introducee report-browse page file to enable the introducee computers to display contents of the report information file for browsing, and
on the server is implemented an introducee report-browse program, which is programmed so as to readout one or more introduction reports for one of the introducees from the report information file, and transmit the introduction report browse page file with the introduction reports laid in, when the introducee computer handled by the introducee has made an access

5. A support system as claimed in the claim 4, wherein
the introducee report-browse page file displays a settlement inputbox for each of the one or more introduction reports,
a settlement register program is implemented on the server,
the settlement register program is to be executed when settlement is input in one or more settlement inputboxes in the introducee report-browse page file after the introducer report-browse file with the one or more introduction report laid in is transmitted to the introducee computer and displayed thereon, and is to record and register the settlement for the introduction reports for which the input has been done, in the report information file.

6. A support system as claimed in the claim 5, wherein
an introducer report-browse page file is memorized in the storage of the server to display contents of the report information file for browsing on the introducer computers,
on the server are implemented
an introducer report-browse program to readout one or more introduction reports for one of the introducers from the report information file when the introducer has made an access by the introducer computer,
a receipt confirmation register program to record and register receipt confirmation in the report information file,
the introducer report-browse page file is to display a receipt confirmation inputbox in addition to the settlement for each introduction report,
the receipt confirmation register program is to be executed when receipt confirmation is input in one or more receipt confirmation inputboxes in the introducer report-browse page file, after the introducer report-browse page file with the one or more introduction reports laid in is transmitted to the introducer computer and displayed thereon, and is to record and register the receipt confirmation for the one or more introduction reports, for which the input has been done, in the report information file.

7. A support system as claimed in the claim 3, wherein
an item information modification page file to make information input to modify the item information recorded in the item information file,
on the server is implemented an item information update program to record the modified item information and update the item information file when the modified item information is input and submitted from one of the introducer computers on which the item information modification page has been displayed, and
in the item information recorded in the report information file, the reward and payment condition for each item are not linked to the reward and payment condition in the item information in the item information file respectively so as not to be modified even when the item information file is updated.

8. A support system as claimed in the claim 1, 2, 3, 4, 5, 6 or 7; wherein
the storage of the server memorizes an introducer-evaluation displaying page file;
on the server is implemented an introducer-evaluation browse program; and
the introducer-evaluation browse program is programmed so as to transmit the number of introduction reports, for which one of the introducers has made submissions of introduction reports and rewards have been paid, to the introducee computers, the number being laid in the introducer-evaluation browse page file as evaluation information of the introducer.

9. A support system as claimed in the claim 1, 2, 3, 4, 5, 6, 7 or 8; wherein
the storage of the server memorizes an introducee-evaluation browse page file;
on the server is implemented an introducee-evaluation browse program; and
the introducee-evaluation browse program is programmed so as to transmit the number of introduction reports, for which items are recorded as those merchandised by one of the introducees and for which rewards have been paid, to the introducer computers, the number being laid in the introducee-evaluation browse page file and transmitted as evaluation information of the introducee to the introducer computers.
